(19) United States
(12) Patent Application Publication
(10) Pub. No.: US 2022/0063631 A1
(43) Pub. Date: Mar. 3, 2022

(54) Chassis Input Intention Prediction Via Brain Machine Interface And Driver Monitoring Sensor Fusion

(71) Applicant: Ford Global Technologies, LLC, Dearborn, MI (US)

(72) Inventors: Ali Hassani, Ann Arbor, MI (US); Aniruddh Ravindran, Sunnyvale, CA (US); Vijay Nagasamy, Fremont, CA (US)

(73) Assignee: Ford Global Technologies, LLC, Dearborn, MI (US)

(21) Appl. No.: 17/008,543

(22) Filed: Aug. 31, 2020

(51) Int. Cl. B60W 40/08; G06F 3/01

(52) U.S. Cl. CPC B60W 40/08; G06F 3/015; B60W 2510/205; B60W 2540/223; B60W 2540/12; B60W 2540/18; B60W 2510/18

(57) ABSTRACT

A sensor-fusion approach of using Brain Machine Interface (BMI) to gain a higher resolution perspective of chassis input control is described according to the present disclosure. Traditional chassis control inputs, such as steering wheel, brake and driver state monitoring sensors can calculate input but often cannot well predict intent. By interpreting well known motor command signals, it can become clear how much chassis input the driver was intending to provide. The BMI may monitor motor cortex to identity when a muscular movement is imminent, such as the movement of the arms to grasp the steering wheel. This combination would enable faster and more precise intent calculation. Additionally, information from driver wearable devices may be used to supplement the determination. This allows for a faster response and well as better integration with the driver.

### BACKGROUND

Brain machine interface (BMI) is a technology that enables humans to provide commands to computers using human brain activity. BMI systems provide control input by interfacing an electrode array with the motor cortex region of the brain, either externally or internally, and decoding the activity signals using a trained neural decoder that translates neuron firing patterns in the user's brain into discrete vehicle control commands.

BMI interfaces can include either invasive direct-contact electrode interface techniques that work with internal direct contact with motor cortex regions, or include non-invasive electrode interface techniques, where wireless receivers utilize sensors to measure electrical activity of the brain to determine actual as well as potential electrical field activity using functional magnetic resonance imaging (fMRI), electroencephalography (EEG), or electric field encephalography (EFEG) receivers that may externally touch the scalp, temples, forehead, or other areas of the user's head. BMI systems generally work by sensing the electrical field activity or potential electrical field activity, amplifying the data, and processing the signals through a digital signal processor to associate stored patterns of brain neural activity with functions that may control devices or provide some output using the processed signals.

Recent advancements in BMI technology have contemplated aspects of vehicle control using BMIs. On aspect of such vehicle control includes driver intention determination for calibrating driver assistance responsiveness.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example computing environment in which techniques and structures for providing the systems and methods disclosed herein may be implemented.

FIG. 2 illustrates a functional schematic of an example architecture of an automotive control system for use with the vehicle, in accordance with the present disclosure.

FIG. 3 depicts an example embodiment for controlling a vehicle using a Brain Machine Interface (BMI) system and a Driver Assistance Technologies (DAT) controller, in accordance with an embodiment.

FIG. 4 illustrates various aspects of a sequence for an example BMI training system in accordance with an embodiment of the present disclosure.

FIG. 5 illustrates a functional schematic and example architecture for a vehicle biometric authentication and occupant monitoring system in accordance with the present disclosure.

FIG. 6 depicts a flow diagram in accordance with the present disclosure.

### DETAILED DESCRIPTION

### Overview

Disclosed is a sensor-fusion approach of using Brain Machine Interface (BMI) to gain a higher resolution perspective of chassis input control. Traditional chassis control inputs, such as steering wheel, brake and driver state monitoring sensors can calculate input but often cannot well predict intent. By interpreting well known motor command signals, it can become clear how much chassis input the driver was intending to provide. This allows for both a faster response and well as better integration with the driver. The BMI may monitor motor cortex activity to identity when a muscular movement is imminent, such as the movement of the arms to grasp the steering wheel. This combination would enable faster and more precise intent calculation. Additionally, information from driver wearable devices may be used to supplement the determination input.

To determine the driver intent, a neural net is trained off the labelled BMI, a Driver State Monitor (DSM) that can monitor eye gaze, head pose, and other driver indicators, and chassis inputs that can include brake pedal, gas pedal, and steering inputs, among other possible inputs. The BMI system may identify a driver intention using the DSM and BMI inputs, and generate a weighted score that indicates the relative urgency or relative importance of the imminent muscle movement.

With respect to braking functions, a brake intent confidence score may be used to determine the appropriate warning intensity level. A driver brake intent score between 1 and 5 may be provided, where 1 is minimal intent (i.e. low leg motor cortex engagement with no brake input) and 5 is maximal intent (i.e. high leg motor cortex engagement with brake engagement and correct eye gaze). In scenarios where the brake intent score is low and collision warning risk is high, the notification system may select more invasive notifications (pop up, HUD flash, audio etc.). In scenarios where the intent score is high and the warning risk is low, the notification may be selected to be more passive (such as a cluster light). This would extend through the various combinations of intent and risk level.

These and other advantages of the present disclosure are provided in greater detail herein.

### Illustrative Embodiments

The disclosure will be described more fully hereinafter with reference to the accompanying drawings, in which example embodiments of the disclosure are shown, and not intended to be limiting.

Driver assistance features, such as pre-collision assist and adaptive front steering, may take driver behavior and the external environment into account, and dynamically adjust vehicle responsiveness. In general these features are desired and improve vehicle safety rating scores; hence the number of applications is dramatically growing. Calibration, however, can be challenge to achieve, as it requires a balance of input sensitivity and latency.

As an example, a driver may be fully engaged when a pre-collision assist event is occurring. In an example scenario, a vehicle may be driving in a lane adjacent to an upcoming exit ramp. If a vehicle in front of the driver is slowing down to take the exit, the driver may recognize this, but have reduced time to avoid a collision. A conventional driver assist system may thus perform a time-to-collision estimation and engage the collision avoidance solutions to mitigate or avoid collision.

In another example, the vehicle in front of the driver slows down to take the exit and the driver recognizes this, but the time-to-collision estimation engages the collision avoidance solutions, when this was not needed. This can result in undesired heads up display indications, as well as unnecessary vehicle assist actions such as an engaged application of greater braking forces than the driver would have used, e.g. to more gently slow down the vehicle.

Conventional systems may benefit from determination of driver intent to calibrate the chassis control command associated with the collision avoidance system engagement. Traditional chassis inputs (such as steering wheel resistance) may not provide consistent inputs that can reliably inform a vehicle system that is configured and/or programmed to predict driver intention. Camera based solutions are an improvement over traditional chassis inputs, but may be limited due to obstructed views, and may not have sufficient information to predict the driver's intention until enough actions have visually taken place to classify it. Accordingly, there is a clear need for a higher fidelity metric of driver intent for the purpose of better calibrating driver assistance responsiveness.

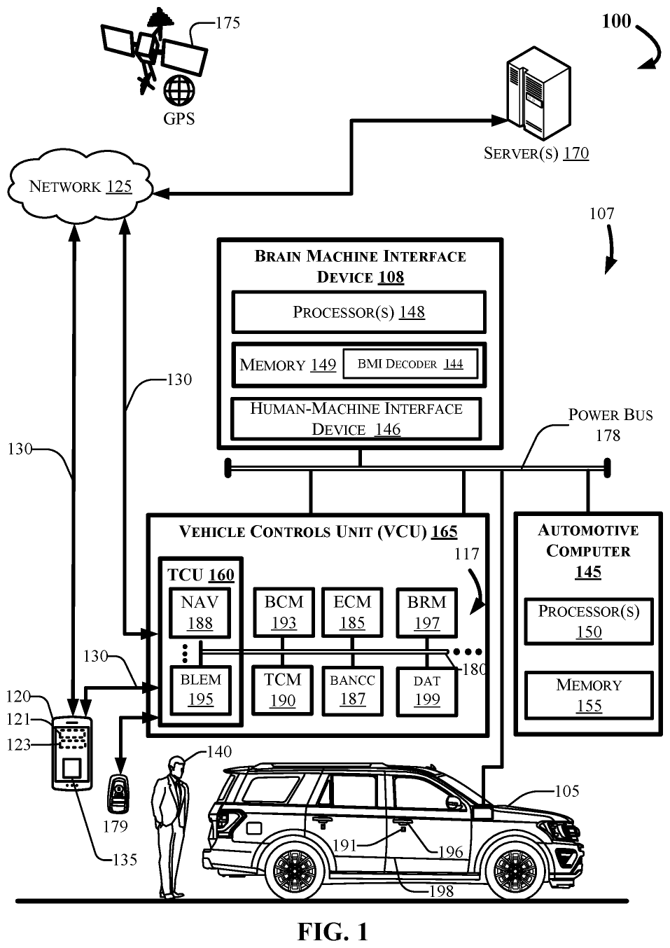

FIG. 1 depicts an example computing environment 100 that can include a vehicle 105 comprising an automotive computer 145, and a Vehicle Controls Unit (VCU) 165 that typically includes a plurality of electronic control units (ECUs) 117 disposed in communication with the automotive computer 145 and a BMI device 108. A mobile device 120, which may be associated with a user 140 and the vehicle 105, may connect with the automotive computer 145 using wired and/or wireless communication protocols and transceivers. The mobile device 120 may be communicatively coupled with the vehicle 105 via one or more network(s) 125, which may communicate via one or more wireless channel(s) 130, and/or may connect with the vehicle 105 directly using near field communication (NFC) protocols, Bluetooth® protocols, Wi-Fi, Ultra-Wide Band (UWB), and other possible data connection and sharing techniques.

The vehicle 105 may also receive and/or be in communication with a Global Positioning System (GPS) 175. The GPS 175 may be a satellite system (as depicted in FIG. 1) such as the global navigation satellite system (GLNSS), Galileo, or navigation or other similar system. In other aspects, the GPS 175 may be a terrestrial-based navigation network, or any other type of positioning technology known in the art of wireless navigation assistance.

The automotive computer 145 may be or include an electronic vehicle controller, having one or more processor(s) 150 and memory 155. The automotive computer 145 may, in some example embodiments, be disposed in communication with the mobile device 120, and one or more server(s) 170. The server(s) 170 may be part of a cloud-based computing infrastructure, and may be associated with and/or include a Telematics Service Delivery Network (SDN) that provides digital data services to the vehicle 105 and other vehicles that may be part of a vehicle fleet.

Although illustrated as a sport utility, the vehicle 105 may take the form of another passenger or commercial automobile such as, for example, a car, a truck, a high performance vehicle, a crossover vehicle, a van, a minivan, a taxi, a bus, etc., and may be configured and/or programmed to include various types of automotive drive systems. Example drive systems can include various types of internal combustion engine (ICE) powertrains having a gasoline, diesel, or natural gas-powered combustion engine with conventional drive components such as, a transmission, a drive shaft, a differential, etc. In another configuration, the vehicle 105 may be configured as an electric vehicle (EV). More particularly, the vehicle 105 may include a battery EV (BEV) drive system, or be configured as a hybrid EV (HEV) having an independent onboard powerplant, a plug-in HEV (PHEV) that includes a HEV powertrain connectable to an external power source, and/or includes a parallel or series hybrid powertrain having a combustion engine powerplant and one or more EV drive systems. HEVs may further include battery and/or supercapacitor banks for power storage, flywheel power storage systems, or other power generation and storage infrastructure. The vehicle 105 may be further configured as a fuel cell vehicle (FCV) that converts liquid or solid fuel to usable power using a fuel cell, (e.g., a hydrogen fuel cell vehicle (HFCV) powertrain, etc.) and/or any combination of these drive systems and components.

Further, the vehicle 105 may be a manually driven vehicle, and/or be configured and/or programmed to operate in a fully autonomous (e.g., driverless) mode (e.g., level-5 autonomy) or in one or more partial autonomy modes. Examples of partial autonomy modes are widely understood in the art as autonomy Levels 0 through 5. A vehicle having a Level-0 autonomous automation may not include autonomous driving features. A vehicle having a Level-1 Driver Assistance Technologies (DAT) controller may generally include a single automated driver assistance feature, such as steering or acceleration assistance. Adaptive cruise control is one such example of a Level-1 driver assistance system that includes aspects of both acceleration and steering. Level-2 driver assistance in vehicles may provide partial automation of steering and acceleration functionality, where the automated system(s) are supervised by a human driver that performs non-automated operations such as braking and other controls. Level-3 driver assistance in a vehicle can generally provide conditional automation and control of driving features. For example, a Level-3 DAT controller typically includes “environmental detection” capabilities, where the vehicle can make informed decisions independently from a present driver, such as accelerating past a slow-moving vehicle, while the present driver remains ready to retake control of the vehicle if the system is unable to execute the task. Level-4 autonomy includes vehicles having high levels of autonomy that can operate independently from a human driver, but still include human controls for override operation. Level-4 automation may also enable a self-driving mode to intervene responsive to a predefined conditional trigger, such as a road hazard or a system failure. Level-5 autonomy is associated with autonomous vehicle systems that require no human input for operation, and generally do not include human operational driving controls.

According to embodiments of the present disclosure, the BMI system 107 may be configured and/or programmed to operate with a vehicle having a Level-1 or Level-2 DAT controller. Accordingly, the BMI system 107 may provide some aspects of human control to the vehicle 105, when the vehicle is configured with a DAT controller.

The mobile device 120 generally includes a memory 123 for storing program instructions associated with an application 135 that, when executed by a mobile device processor 121, performs aspects of the disclosed embodiments. The application (or “app”) 135 may be part of the BMI system 107, or may provide information to the BMI system 107 and/or receive information from the BMI system 107.

In some aspects, the mobile device 120 may communicate with the vehicle 105 through the one or more channel(s) 130, which may be encrypted and established between the mobile device 120 and a Telematics Control Unit (TCU) 160. The mobile device 120 may communicate with the TCU 160 using a wireless transmitter associated with the TCU 160 on the vehicle 105. The transmitter may communicate with the mobile device 120 using a wireless communication network such as, for example, the one or more network(s) 125. The wireless channel(s) 130 are depicted in FIG. 1 as communicating via the one or more network(s) 125, and via one or more direct connection(s) 133. The connection(s) 133 may include various low-energy protocols including, for example, Bluetooth®, BLE, or other Near Field Communication (NFC) protocols.

The network(s) 125 illustrate an example communication infrastructure in which the connected devices discussed in various embodiments of this disclosure may communicate. The network(s) 125 may be and/or include the Internet, a private network, public network or other configuration that operates using any one or more known communication protocols such as, for example, transmission control protocol/Internet protocol (TCP/IP), Bluetooth®, Wi-Fi based on the Institute of Electrical and Electronics Engineers (IEEE) standard 802.11, Ultra-Wide Band (UWB), and cellular technologies such as Time Division Multiple Access (TDMA), Code Division Multiple Access (CDMA), High Speed Packet Access (HSPDA), Long-Term Evolution (LTE), Global System for Mobile Communications (GSM), and Fifth Generation (5G), to name a few examples.

The automotive computer 145 may be installed in an engine compartment of the vehicle 105 (or elsewhere in the vehicle 105) and operate as a functional part of the BMI system 107, in accordance with the disclosure. The automotive computer 145 may include one or more processor(s) 150 and a computer-readable memory 155.

The one or more processor(s) 150 may be disposed in communication with one or more memory devices disposed in communication with the respective computing systems (e.g., the memory 155 and/or one or more external databases). The processor(s) 150 may utilize the memory 155 to store programs in code and/or to store data for performing aspects in accordance with the disclosure. The memory 155 may be a non-transitory computer-readable memory storing a BMI program code. The memory 155 can include any one or a combination of volatile memory elements (e.g., dynamic random access memory (DRAM), synchronous dynamic random access memory (SDRAM), etc.) and can include any one or more nonvolatile memory elements (e.g., erasable programmable read-only memory (EPROM), flash memory, electronically erasable programmable read-only memory (EEPROM), programmable read-only memory (PROM), etc.

The VCU 165 may share a power bus 178, and may be configured and/or programmed to coordinate the data between vehicle 105 systems, connected servers (e.g., the server(s) 170), and other vehicles operating as part of a vehicle fleet. The VCU 165 can include or communicate with any combination of the ECUs 117, such as, for example, a Body Control Module (BCM) 193, an Engine Control Module (ECM) 185, a Transmission Control Module (TCM) 190, the TCU 160, a Body and Network Communication Controller (BANCC) 187, etc. In some aspects, the VCU 165 may control aspects of the vehicle 105, and implement one or more instruction sets received from the application 135 operating on the mobile device 120, from one or more instruction sets received from the BMI system 107, and/or from instructions received from the DAT controller 199.

The TCU 160 can be configured and/or programmed to provide vehicle connectivity to wireless computing systems onboard and offboard the vehicle 105, and may include a Navigation (NAV) receiver 188 for receiving and processing a GPS signal from the GPS 175, a Bluetooth® Low-Energy (BLE) Module (BLEM) 195, a Wi-Fi transceiver, an Ultra-Wide Band (UWB) transceiver, and/or other wireless transceivers that may be configurable for wireless communication between the vehicle 105 and other systems, computers, and modules. The TCU 160 may be disposed in communication with the ECUs 117 by way of a bus 180. In some aspects, the TCU 160 may retrieve data and send data as a node in a CAN bus.

The BLEM 195 may establish wireless communication using Bluetooth® and Bluetooth Low-Energy® communication protocols by broadcasting and/or listening for broadcasts of small advertising packets, and establishing connections with responsive devices that are configured according to embodiments described herein. For example, the BLEM 195 may include Generic Attribute Profile (GATT) device connectivity for client devices that respond to or initiate GATT commands and requests, and connect directly with the mobile device 120, and/or one or more keys (which may include, for example, the fob 179).

The bus 180 may be configured as a Controller Area Network (CAN) bus organized with a multi-master serial bus standard for connecting two or more of the ECUs 117 as nodes using a message-based protocol that can be configured and/or programmed to allow the ECUs 117 to communicate with each other. The bus 180 may be or include a high speed CAN (which may have bit speeds up to 1 Mb/s on CAN, 5 Mb/s on CAN Flexible Data Rate (CAN FD)), and can include a low-speed or fault tolerant CAN (up to 125 Kbps), which may, in some configurations, use a linear bus configuration. In some aspects, the ECUs 117 may communicate with a host computer (e.g., the automotive computer 145, the BMI system 107, and/or the server(s) 170, etc.), and may also communicate with one another without the necessity of a host computer. The bus 178 may connect the ECUs 117 with the automotive computer 145 such that the automotive computer 145 may retrieve information from, send information to, and otherwise interact with the ECUs 117 to perform steps described according to embodiments of the present disclosure. The bus 180 may connect CAN bus nodes (e.g., the ECUs 117) to each other through a two-wire bus, which may be a twisted pair having a nominal characteristic impedance. The bus 180 may also be accomplished using other communication protocol solutions, such as Media Oriented Systems Transport (MOST) or Ethernet. In other aspects, the bus 180 may be a wireless intra-vehicle bus.

The VCU 165 may control various loads directly via the bus 180 communication or implement such control in conjunction with the BCM 193. The ECUs 117 described with respect to the VCU 165 are provided for example purposes only, and are not intended to be limiting or exclusive. Control and/or communication with other control modules is possible, and such control is contemplated.

In an example embodiment, the ECUs 117 may control aspects of vehicle operation and communication using inputs from human drivers, inputs from an autonomous vehicle controller, the BMI system 107, and/or via wireless signal inputs received via the wireless channel(s) 133 from other connected devices such as the mobile device 120, among others. The ECUs 117, when configured as nodes in the bus 180, may each include a central processing unit (CPU), a CAN controller, and/or a transceiver. For example, although the mobile device 120 is depicted in FIG. 1 as connecting to the vehicle 105 via the BLEM 195, it is possible and contemplated that the wireless connection 133 may also or alternatively be established between the mobile device 120 and one or more of the ECUs 117 via the respective transceiver(s) associated with the module(s).

The BCM 193 generally includes integration of sensors, vehicle performance indicators, and variable reactors associated with vehicle systems, and may include processor-based power distribution circuitry that can control functions associated with the vehicle body such as lights, windows, security, door locks and access control, and various comfort controls. The BCM 193 may also operate as a gateway for bus and network interfaces to interact with remote ECUs.

The BCM 193 may coordinate any one or more functions from a wide range of vehicle functionality, including energy management systems, alarms, vehicle immobilizers, driver and rider access authorization systems, Phone-as-a-Key (PaaK) systems, driver assistance systems, AV control systems, power windows, doors, actuators, and other functionality, etc. The BCM 193 may be configured for vehicle energy management, exterior lighting control, wiper functionality, power window and door functionality, heating ventilation and air conditioning systems, and driver integration systems. In other aspects, the BCM 193 may control auxiliary equipment functionality, and/or be responsible for integration of such functionality.

In some aspects, the vehicle 105 may include one or more Door Access Panels (DAPs) disposed on exterior door surface(s) of vehicle door(s) 198, and connected with a DAP controller. In some aspects, the user 140 may have the option of entering a vehicle by typing in a personal identification number (PIN) on an interface associated with a vehicle. The user interface may be included as part of a Door Access Panel (DAP) interface, a wireless keypad, mobile device, or other interface. The DAP system, which may be included as part of the BANCC 187 or another of the ECUs 117, can include and/or connect with an interface with which a ridehail passenger (or any other user such as the user 140) may input identification credentials and receive information from the system. In one aspect, the interface may be or include a DAP 191 disposed on a vehicle door 198, and can include an interface device from which the user can interact with the system by selecting their unique identifier from a list, and by entering personal identification numbers (PINs) and other non-personally identifying information. In some embodiments, the interface may be a mobile device, a keypad, a wireless or wired input device, a vehicle infotainment system, and/or the like. Accordingly, it should be appreciated that, although a DAP is described with respect to embodiments herein, the interface may alternatively be one or more other types of interfaces described above.

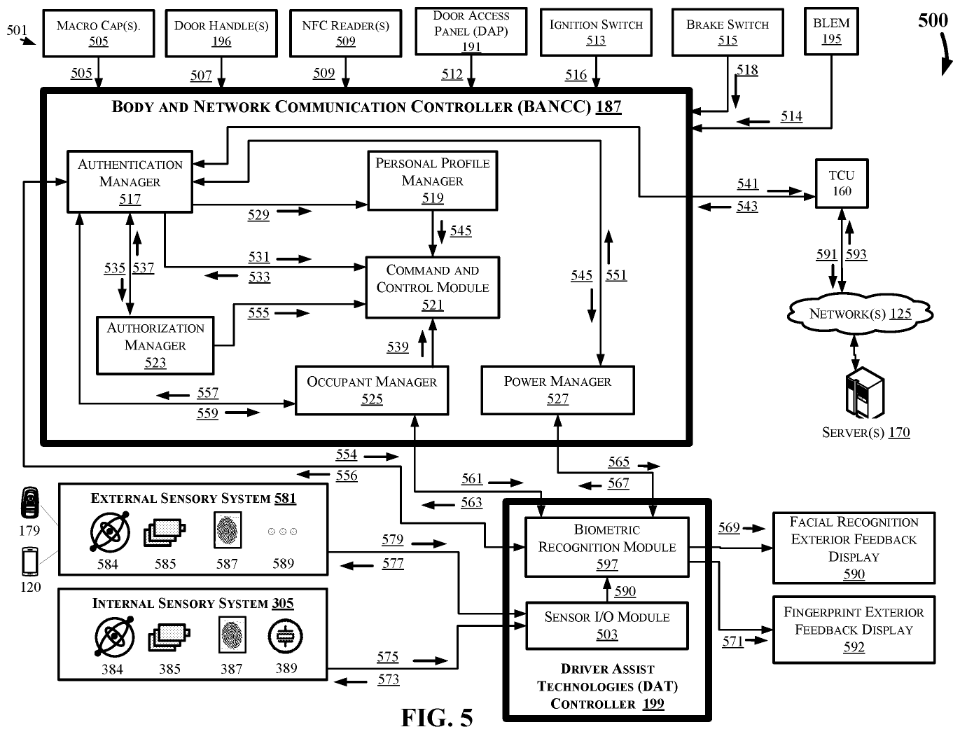

The BANCC 187, described in greater detail with respect to FIG. 5, can include sensory and processor functionality and hardware to facilitate user and device authentication, and provide occupant customizations and support that provide customized experiences for vehicle occupants.

The BANCC 187 may connect with the DAT controller 199 configured and/or programmed to provide biometric authentication controls, including, for example, facial recognition, fingerprint recognition, voice recognition, and/or other information associated with characterization, identification, and/or verification for other human factors such as gait recognition, body heat signatures, eye tracking, etc. The VCU 165 may, in some example embodiments, utilize the DAT controller 199 to obtain sensor information from sensors disposed on the vehicle interior and/or exterior, and characterize the sensor information for identification of biometric markers stored in a secure biometric data vault onboard the vehicle 105 and/or via the server(s) 170. In other aspects, the DAT controller 199 may also be configured and/or programmed to control Level-1 and/or Level-2 driver assistance. The DAT controller 199 may connect with and/or include a Vehicle Perception System (VPS) 186, which may include internal and external sensory systems (described in greater detail with respect to FIG. 5). The sensory systems may be configured and/or programmed to obtain sensor data usable for biometric authentication.

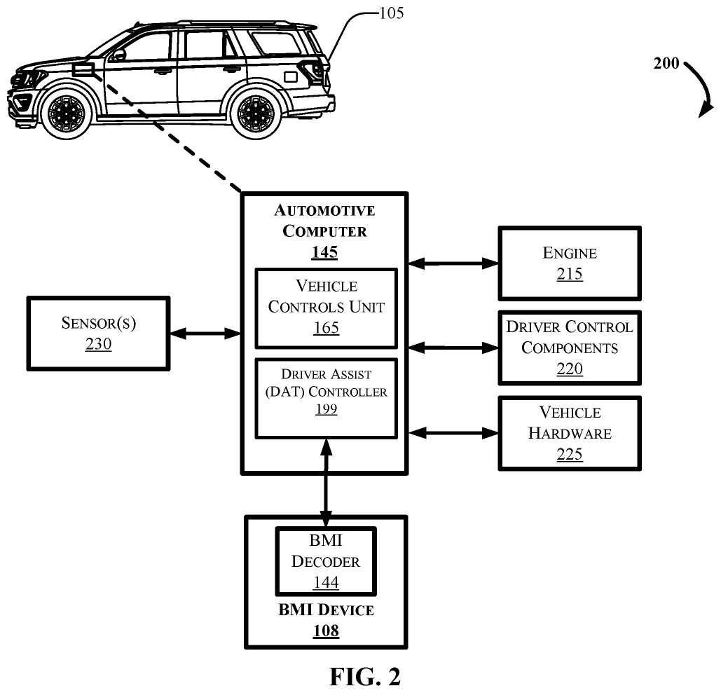

The vehicle 105, in the embodiment depicted in FIG. 2, may include a Level-1, Level-2 or Level 3 DAT controller 199. The automotive computer 145 may control input from the BMI system 107 that operates the BMI decoder 144 via the BMI device 108, operate a continuous data feed of neural data from a user (e.g., the user 140), and determine a user intention for a chassis control command from the continuous neural data feed. The computing system architecture of the automotive computer 145, VCU 165, and/or the BMI system 107 may omit certain computing modules. It should be readily understood that the computing environment depicted in FIG. 1 is an example of a possible implementation according to the present disclosure, and thus, it should not be considered limiting or exclusive.

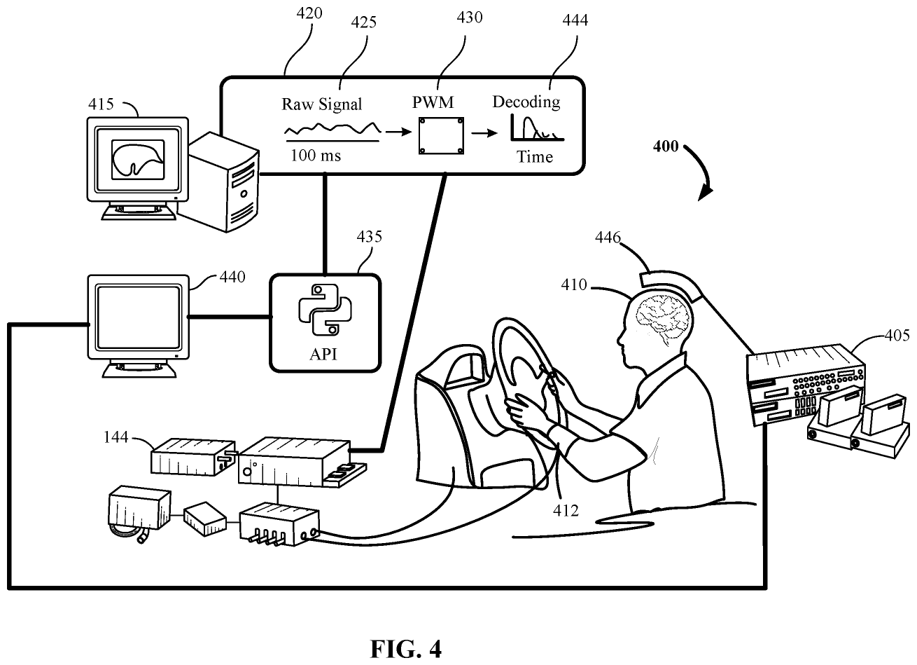

Interpreting neural data from the motor cortex of a user's brain is possible when the BMI device 108 is trained and tuned to a particular user's neural activity. The training procedures (discussed in greater detail with respect to FIG. 4) can include systematically mapping a continuous neural data feed observed and recorded by a training computer system.

FIG. 2 illustrates a functional schematic of an example architecture of an automotive control system 200 that may be used for control of the vehicle 105, in accordance with the present disclosure. The control system 200 may include the BMI system 107, which may be disposed in communication with the automotive computer 145, and vehicle control hardware including, for example, an engine/motor 215, driver control components 220, vehicle hardware 225, sensor(s) 230, and the mobile device 120 and other components.

The sensors 230 may include any number of devices configured or programmed to generate signals that help navigate the vehicle 105 when it is operating in an autonomous mode. Examples of autonomous driving sensors 230 may include a Radio Detection and Ranging (RADAR or “radar”) sensor configured for detection and localization of objects using radio waves, a Light Detecting and Ranging (LiDAR or “lidar”) sensor, a vision sensor system having trajectory, obstacle detection, object classification, augmented reality, and/or other capabilities, and/or the like. The autonomous driving sensors 230 may help the vehicle 105 “see” the roadway and the vehicle surroundings and/or negotiate various obstacles while the vehicle is operating in the autonomous mode.

The automotive computer 145 may receive control input from the BMI system 107 that operates the BMI decoder 144 via the BMI device 108, operates a continuous data feed of neural data from a user (e.g., the user 140), and determines a user intention for a chassis control command from the continuous neural data feed. The BMI device 108 may include one or more processor(s) 148 disposed in communication with a computer-readable memory 149 and a human-machine interface (HMI) 146. The memory 149 may include executable program code for a BMI decoder 144.

Interpreting neural data from the motor cortex of a user's brain is possible when the BMI device 108 is trained and tuned to a particular user's neural activity. The training procedures can include systematically mapping a continuous neural data feed obtained from that user, where the data feed provides quantitative values associated with user brain activity as the user provides manual input into a training computer system, and more particularly, as the user provides control of a pointer. The training computer system may form associations for patterns of neural cortex activity (e.g., a correlation model) as the user performs exercises associated with vehicle operation by controlling the pointer, and generating a correlation model that can process continuous data feed and identify neural cortex activity that is associated with control functions.

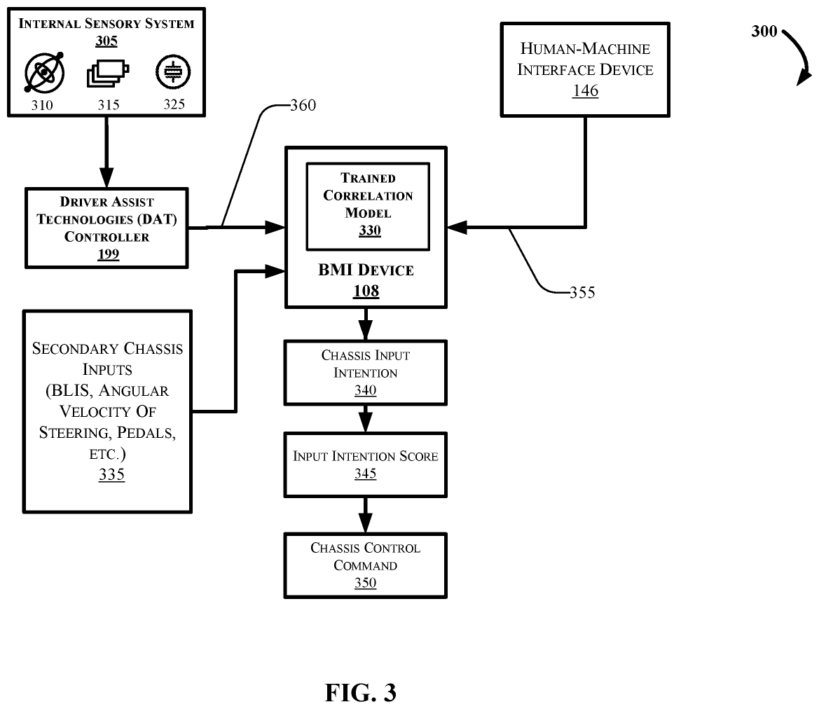

The BMI decoder 144 may determine, from the continuous data feed of neural data, a user intention for a chassis input by matching the user intention to a DAT control function. The BMI system 107 may use a trained correlation model to form such an association, and further evaluate the continuous data feed of neural data to determine a user engagement value. The BMI system 107 may also receive, from the DAT controller 199, a second continuous data feed indicative of a muscle movement. The muscle movement may be a slight action such as a twitch of the driver's calf muscle as the driver prepares for a braking action using the foot pressing on the accelerator pedal. Although the action is slight, in one embodiment, the internal sensory system 305 may observe the user's action using an internal sensory system (e.g., the internal sensory system 305 as shown in FIG. 3), which may include camera sensors, piezoelectric sensor(s), inertial measurement units, and/or other sensors. It should be appreciated that, in conventional user intention detection systems, camera data alone may not provide a sufficient indication of movements associated with chassis control intentions. However, as explained in the following section, using a combination of a first continuous data feed that includes neural command signals associated with an imminent muscle movement to execute a chassis input, plus a secondary sensor indication of the movement received from the DAT controller 199, the BMI system 107 may determine a chassis input intention, and execute the chassis control command based on the chassis input intention. Accordingly, the BMI system 107 may send the instruction to the DAT controller 199. When configured with the trained BMI device that uses the trained correlation model, the DAT controller 199 may provide vehicle control by performing some aspects of vehicle operation, and by configuring DAT systems according to particular user preferences.

FIG. 3 depicts a flow diagram 300 for an example embodiment for controlling a vehicle using the BMI system 107 and the DAT controller 199, in accordance with an embodiment. FIG. 3 will be described with continued reference to elements depicted in FIGS. 1 and 2.

The flow diagram 300 describes a sensor fusion approach of combining a brain machine interface (BMI) device 108 with traditional driver state monitoring and chassis input sensors (e.g., an internal sensory system 305) to more robustly calculate driver intent. The flow diagram 300 describes a process whereby the BMI system 107 monitors the user's neural cortex activity while driving the vehicle 105 to provide assistance and preemptive configuration of DAT control commands that can assist the driver. The BMI device 108 may measure neural activity through the human-machine interface device 146, which may include implantable BMIs (i.e. those users with a robotic prosthetic limb would already have one), as well as non-contact electric field encephalography (EFEG) devices that may be integrated into a headrest.

According to one embodiment, the BMI device 108 may determine a chassis input intention 340 based on two inputs: a continuous data feed that includes neural command signals associated with an imminent muscle movement to execute a chassis input, and (2) a second continuous data feed indicative of the anticipated muscle movement. The first continuous data feed includes neural activity 355 of the user 140 as they operate the vehicle 105. To perform this function, the BMI device 108 may monitor the motor cortex of the user 140 via the human-machine interface device 146 (described with respect to FIG. 1) to identify when a muscular movement is imminent, such as the movement of the arms to grasp the steering wheel, or the movement of a calf muscle in preparation for engaging the vehicle braking system.

The second continuous data feed may originate from a Driver Assist Technologies (DAT) controller 199 disposed in communication with the BMI device 108 to provide sensory information 360 obtained via an internal sensory system 305. In one embodiment, the sensory information 360 may originate from a camera feed of the vehicle interior, where the viewing aspect(s) show views of the driver operating the vehicle 105. The BMI device 108 may determine user muscular movement(s) that are consistent with the neural activity 355. The sensory information may include piezoelectric sensor information from a piezoelectric sensor 325, inertia information from an IMU 310, video information from vehicle cameras 315, or other sensory information such as thermal imaging information, audio inputs, etc.

By combining the DAT controller continuous data feed of sensory information 360, and the HMI device 146 continuous data feed of neural activity 355, the BMI device 108 may provide timely and precise chassis input intention calculations, that may be used by the DAT controller to bias brake gain, bias steering gain and ratio adaptation, and reduce unneeded warning notifications on a heads up display (HUD).

The BMI device 108 may further include one or more secondary inputs that may be used to bias or weight the chassis input intention 340. The secondary inputs 335 may include a Blind Spot Information System (BLIS) data feed, measurements of angular velocity of the steering wheel, brake pedals, etc., force information, rotational velocity information, and inertial measurements, among other possibilities. If the driver chooses to use wearable devices that have surface electrodes, such as fitness trackers or intelligent socks/shoes, this data may also be fed into the BMI device 108, as an input to a neural network that adjusts weights based on whether such devices are detected. The secondary inputs 335 may provide additional accuracy for scoring calculations.to ensure the proper score calculation is made.

One aspect of chassis control command that the BMI system 107 may provide control assistance with can include brake gain. Brake gain may be associated with a degree of stopping force applied to vehicle brakes given chassis control inputs. In one embodiment, the BMI system 107 may determine driver intent, and evaluate environmental aspect to assign an input intention score 345. To determine the driver intent, a trained neural net (e.g., the trained correlation model 330) that was trained off the labelled BMI may receive Driver State Monitoring (DSM) signals that can include eye gaze, head pose, etc., and use the DSM signals in conjunction with chassis inputs (brake pedal actuation, gas pedal actuation, and steering control input) to evaluate inputs, relative forces, and time factors associated with the inputs, to provide weights for the inputs that can indicate the relative importance of the respective input. The BMI device 108 may output an input intention score 345. In one example, where the chassis input intention is a brake actuation, the input intention score 345 may include a brake intent score between 1 and 5, where 1 is a minimal intent (e.g., a low leg motor cortex engagement with no brake input), and 5 is maximal intent (e.g., a high leg motor cortex engagement with brake engagement and correct eye gaze).

In another embodiment, where the chassis input intention indicates that the user 140 intends to make a steering adjustment, the BMI device 108 may calculate a steering intention by training the correlation model neural net via the BMI, DSM signals (e.g., eye gaze, among other possibilities), and the secondary inputs 335 comprising, e.g., chassis inputs (e.g., the brake pedal, gas pedal, and steering inputs). In a second example, where the chassis input intention is a steering actuation, the input intention score 345 may include a score between 1 and 5, where 1 indicates a minimal intent (e.g., an arm motor cortex engagement with eye gaze out of view) and 5 indicates a maximal intent (e.g., a high arm motor cortex engagement with steering wheel input and correct gaze).

For vehicles that incorporate an adaptive personal profile, the driver intent model can be continuously updated based on a historical record of brake pedal usage, which the DAT may record in persistent computer memory. The historical record may provide data input for a reinforcement learning algorithm associated with brake pedal usage that can include providing rewards when the predicted brake gain results in minimal brake pedal velocity (i.e. driver holds brake pedal in same spot for given intent), and providing negative reward when the predicted gain results in significant variation in pedal position.

In other aspects, a similar reinforcement learning model may improve steering ratio and steering gain operations. For example, in vehicles that support an adaptive user profile, the driver intent model will be continuously updated based on how the steering usage is recorded. This includes providing rewards when the predicted gain and ratio result in minimal steering wheel angular velocity (e.g., the driver has to provide minimal input to accomplish a maneuver), and providing negative rewards when the predicted gain and ratio result in significant angular velocity values.

FIG. 4 illustrates an example BMI training system 400, in accordance with an embodiment of the present disclosure. The BMI training system 400 may include a neural data acquisition system 405, a training computer 415 with digital signal processing (DSP) decoding, and an application programming interface (API) 435.

The system 400 may form associations for patterns of neural cortex activity as the user performs exercises associated with vehicle operation. The training computer 415 may obtain the continuous feed from a user via the human-machine interface device 146 (as shown in FIG. 1), where the data feed provides quantitative values associated with user brain activity as the user 410 provides manual chassis inputs during the simulated driving activity, and the training computer system observes neural responses associated with various simulated (or actual) chassis inputs. The training computer system may then generate a correlation model that can process continuous data feed and identify neural cortex activity that is associated with muscle movements made in preparation for executing various chassis inputs (e.g., steering, braking, accelerating, etc.).

To determine the driver's intention, the BMI decoder 144 may determine, from the continuous data feed of neural data, a user intention for the chassis input by matching the user intention to an observed neural activity. The BMI system 107 may use the trained correlation model 330 (as shown in FIG. 3) to form such an association, and further evaluate the continuous data feed of neural data to determine or estimate the user's intention associated with brain activity and muscle movements.

The neural data acquisition system 405 and the training computer 415 may be and/or include components from a conventional neural bridging system. One such example of a conventional neural bridging system is described in the publication titled, “Towards a Modular Brain-Machine Interface for Intelligent Vehicle Systems Control—A CARLA Demonstration” (Dunlap et al., presented at 2019 IEEE International Conference on Systems, Man and Cybernetics (SMC) on Oct. 5, 2019), which is incorporated herein by reference.

Reinforcement learning is a machine learning technique that may be used to take a suitable action that maximizes reward in a particular situation, such that the machine learns to find an optimal behavior or path to take given a specific situation. More particularly, the system 300 may use a reward function to give a reward if the compensated gesture recognition provides the expected command. This reward may enable the BMI training system 300 to include the latest offset data for greater tolerance. Conversely, if the compensated neural output does not generate the expected gesture recognition, the system 300 may reduce the reward function tolerance on gesture recognition, and require the driving feature to pause for a predetermined period of time.

For example, say an aggressive change in steering, (e.g., a relatively high steering wheel angular velocity) where the driver applies a lower relative force/effort to steer the vehicle, is associated with a positive reward. The system 300 may use the error function defined here to determine if the guess is correct every few samples. For example, if the motion initially starts as expected, then slowly increases in error that appears within an allowed threshold (as defined by either motion offset or correlation coefficient of neural firing pattern) the system 300 may give positive reward to retain the gesture. After accumulating sufficient reward, the system 300 may add a new gesture state to the decoder to define how the user's gesture deviates after extended use. The added new gesture state may reduce the error function the following time the user does the command to improve user experience.

Conversely, if the error function exceeds the threshold value, the system 300 may apply a negative reward. If this drops below a given threshold the system 300 may then assume the user is not making the intended gesture, and provide notification that gesture is no longer recognized. If the user makes the same incorrect gesture for a given predicted use case (such as, for example, the motive command), the system 300 may inform the user that the system 300 is being updated to take this new behavior as the expected input. This could alternatively be done as a prompt asking whether the user would like the system to be trained to the new behavior.

This reward function may ideally take the predicted gesture value, error value, and a previous input history into account in order to dynamically update the system. The predicted gesture value, error value and the input history may be used to establish a feedback system that operates in a semi-supervised fashion. Stated in another way, the system 300 may train the reward function first, then predict the expected behavior to update the model over time, based on the reward score.

By way of a brief overview, the following paragraphs will provide a general description for an example method of training the BMI system 107 using the BMI training system 400. In one aspect, a user 410 may interact with a manual input device 412 and provide inputs to the BMI training system. The BMI training system 400 may generate a decoding model, based on the user inputs, for interpreting neural cortex brain activity associated with this particular user. For example, the BMI training system 400 may present a pointer 438 on a display device of a training computer 440. The user 410 may provide manual input using the manual input device 412, where the manual input includes moving the pointer 438 on the display device of the training computer 440. In one aspect, the user 410 may provide these manual control inputs while operating a driving simulation program. While the user 410 performs the manual inputs, The BMI training system 400 may also obtain the neural data using the neural data acquisition system 405. The BMI training system 400 may collect the neural data (e.g., raw data input) and perform a comparison procedure whereby the user 410 performs imagined movements of the user body gesture 450 (which may include imagining use of an input arm 454), and where the imagined inputs can include a hand close, a hand open, a forearm pronation, a forearm supination, and finger flexion. Some embodiments may include performing the comparison procedure while the neural data acquisition system 405 obtains raw signal data from a continuous neural data feed indicative of brain activity of the user 410.

Obtaining the continuous neural data feed may include receiving, via the training computer 440, neural data input as a time series of decoder values from a microelectrode array 446. For example, the neural data acquisition system 405 may obtain the neural data by sampling the continuous data feed at a predetermined rate (e.g., 4 decoder values every 100 ms, 2 decoder values every 100 ms, 10 decoder values every 100 ms, etc.). The BMI training system 400 may generate a correlation model that correlates the continuous neural data feed to a chassis control command. The BMI training system may save the decoder values 425 to a computer memory 430, then convert the decoder values to motor cortex mapping data using pulse width modulation and other DSP techniques via a digital signal processor 420. The BMI decoder 144 may map data to aspects of vehicle control, such as, for example, velocity and steering control commands.

The microelectrode array 446 may be configured to receive the continuous neural data of neural cortex activity gathered from the user 410. The neural data may originate, for example, in response to neural activity generated from the user's brain as the user 410 imagines a particular body movement associated with vehicle control, and/or performs a manual body movement that is meant to represent such control. In one example procedure, a movement imagined by the user may be mapped to increment a state to a next-contiguous state (e.g., from low speed to medium speed). In another aspect a movement imagined by the user may be mapped to decrement a state to a next-contiguous state (e.g., a reverse action from the increment operation). In another example, the user may imagine a movement for engaging the vehicle into particular states, or combinations of states (e.g., a low velocity during a slight right steering function).

The user 410 may be the same user as shown in FIG. 1, who may operate the vehicle with the trained BMI system 107, where the training procedure is specific to that particular user. In another aspect, the training procedure may provide a correlation model that correlates the continuous neural data feed to vehicle control functions, where the generalized correlation model applies a generalized neural cortex processing function to a wider array of possible neural patterns. In this respect, the generalized model may be readily adopted by any user with some limited tuning and training. One method contemplated to produce a generalized model may include, for example, the use of machine learning techniques that include deep neural network correlation model development.

The microelectrode array 446 may be configured to obtain neural data from the primary motor cortex of a user 410 which data were acquired through an invasive or non-invasive neural cortex connection. For example, in one aspect, an invasive approach to neural data acquisition may include an implanted 96-channel intracortical microelectrode array configured to communicate through a port interface (e.g., a NeuroPort® interface, currently available through Blackrock Microsystems, Salt Lake, Utah). In another example embodiment, using a non-invasive approach, the microelectrode array 346 may include a plurality of wireless receivers that wirelessly measure brain potential electrical fields using an electric field encephalography (EFEG) device.

The training computer 415 may receive the continuous neural data feed via wireless or wired connection (e.g., using an Ethernet to PC connection) from the neural data acquisition system 405. The training computer 415 may be, in one example embodiment, a workstation running a MATLAB®-based signal processing and decoding algorithm. Other math processing and DSP input software are possible and contemplated. The BMI training system may generate the correlation model that correlates the continuous neural data feed to vehicle control functions using Support Vector Machine (SVM) Learning Algorithms (LIBSVM) to classify neural data into finger/hand/forearm movements (supination, pronation, hand open, hand closed, and finger flexion).

The finger, hand, and forearm movements (hereafter collectively referred to as “hand movements 450”) may be user-selected for their intuitiveness in representing vehicle driving controls (rightward turning, leftward turning, acceleration, and deceleration, respectively). For example, the BMI training system may include an input program configured to prompt the user 410 to perform a gesture that represents turning right, and the BMI training system may record the manual input and neural cortex brain activity associated with the responsive user input. Decoded hand movements may have been displayed to the user as movements of a hand animation. In another aspect, the BMI training system may include a neuromuscular electrical stimulator system to obtain feedback of neural activity and provide the feedback to the user 410 based on the user's motor intent.

In some aspects, the BMI training system 400 may convert the neural data to a vehicle control command instruction associated with one or more vehicle control functions. In one example embodiment, the BMI training system 400 may match user intention to a chassis input control command associated with a user intention for a vehicle control action. Vehicle control actions may be, for example, steering functions that can include turning the vehicle a predetermined amount (which may be measured, for example, in degrees with respect to a forward direction position), or vehicle functions that can include changing a velocity of the vehicle.

FIG. 5 illustrates a functional schematic of a biometric authentication and occupant monitoring system 500 that may be used for providing vehicle control using biometric information, the BMI system 107, and for providing user support and customization for the vehicle 105, in accordance with the present disclosure.

The biometric authentication and occupant monitoring system 500 may authenticate passive device signals from a PEPS-configured device such as the mobile device 120, a passive key device such as the fob 179, and provide vehicle entry and signal authentication using biometric information and other human factors. The biometric and occupant monitoring system 500 may also provide user support and customizations to enhance user experience with the vehicle 105. The authentication and occupant monitoring system 500 can include the BANCC 187, which may be disposed in communication with the DAT 199, the TCU 160, the BLEM 195, and a plurality of other vehicle controllers 501, which may include vehicle sensors, input devices, and mechanisms. Examples of the plurality of other vehicle controllers 501 can include, one or more macro capacitor(s) 505 that may send vehicle wakeup data 506, the door handle(s) 196 that may send PEPS wakeup data 507, NFC reader(s) 509 that send NFC wakeup data 510, the DAPs 191 that send DAP wakeup data 512, an ignition switch 513 that can send an ignition switch actuation signal 516, and/or a brake switch 515 that may send a brake switch confirmation signal 518, among other possible components.

The DAT controller 199 may include and/or connect with a biometric recognition module 597 disposed in communication with the DAT controller 199 via a sensor Input/Output (I/O) module. The BANCC 187 may connect with the DAT controller 199 to provide biometric authentication controls, including, for example, facial recognition, fingerprint recognition, voice recognition, and/or other information associated with characterization, identification, and/or verification for other human factors such as gait recognition, body heat signatures, eye tracking, etc.

The DAT controller 199 may be configured and/or programmed to provide biometric authentication control for the vehicle 105, including, for example, facial recognition, fingerprint recognition, voice recognition, and/or other provide authenticating information associated with characterization, identification, occupant appearance, occupant status, and/or verification for other human factors such as gait recognition, body heat signatures, eye tracking, etc. The DAT controller 199 may obtain the sensor information from an external sensory system 581, which may include sensors disposed on a vehicle exterior and in devices connectable with the vehicle 105 such as the mobile device 120 and/or the fob 179.

The DAT controller 199 may further connect with the internal sensory system 305, which may include any number of sensors configured in the vehicle interior (e.g., the vehicle cabin, which is not depicted in FIG. 5). The external sensory system 581 and internal sensory system 305 can connect with and/or include one or more inertial measurement units (IMUs) 584, camera sensor(s) 585, fingerprint sensor(s) 587, and/or other sensor(s) 589, and obtain biometric data usable for characterization of the sensor information for identification of biometric markers stored in a secure biometric data vault onboard the vehicle 105. The DAT controller 199 may obtain, from the internal and external sensory systems 305 and 581, sensor data that can include external sensor response signal(s) 579 and internal sensor response signal(s) 575 (collectively referred to as sensory data 590), via the sensor I/O module 503. The DAT controller 199 (and more particularly, the biometric recognition module 597) may characterize the sensory data 590, generate occupant appearance and status information 563, and forward the information to the occupant manager 525, which may be used by the BANCC 187 according to described embodiments.

The internal and external sensory systems 305 and 581 may provide the sensory data 579 and 575 obtained from the external sensory system 581 and the internal sensory system 305 responsive to an internal sensor request message 573 and an external sensor request message 577, respectively. The sensory data 579 and 575 may include information from any of the sensors 584-589, where the external sensor request message 577 and/or the internal sensor request message 573 can include the sensor modality with which the respective sensor system(s) are to obtain the sensory data.

The camera sensor(s) 585 may include thermal cameras, optical cameras, and/or hybrid camera having optical, thermal, or other sensing capabilities. Thermal cameras may provide thermal information of objects within a frame of view of the camera(s), including, for example, a heat map figure of a subject in the camera frame. An optical camera may provide a color and/or black-and-white image data of the target(s) within the camera frame. The camera sensor(s) 585 may further include static imaging, or provide a series of sampled data (e.g., a camera feed) to the biometric recognition module 597.

The IMU(s) 584 may include a gyroscope, an accelerometer, a magnetometer, or other inertial measurement device. The fingerprint sensor(s) 587 can include any number of sensor devices configured and/or programmed to obtain fingerprint information. The fingerprint sensor(s) 587 and/or the IMU(s) 584 may also be integrated with and/or communicate with a passive key device, such as, for example, the mobile device 120 and/or the fob 179. The fingerprint sensor(s) 587 and/or the IMU(s) 584 may also (or alternatively) be disposed on a vehicle exterior space such as the engine compartment, door panel, etc. In other aspects, when included with the internal sensory system 305, the IMU(s) 584 may be integrated in one or more modules disposed within the vehicle cabin or on another vehicle interior surface.

The biometric recognition module 597 may be disposed in communication with one or more facial recognition exterior feedback displays 590, which can operate as a user interface accessible to the user 140 outside of the vehicle 105 to provide facial recognition feedback information 569 associated with facial recognition processes described herein. The biometric recognition module 597 may further connect with one or more fingerprint exterior feedback displays 592 that may perform similar communication functions associated with fingerprint recognition processes described herein, including providing fingerprint authentication feedback information 571 to the fingerprint exterior feedback displays 592 accessible to the user 140 outside of the vehicle 105 (also referred to in conjunction with the fingerprint exterior feedback display 592 as “feedback displays”). It should be appreciated that the feedback displays 590 and/or 592 may be and/or include a stationary I/O or other display disposed on the vehicle, the mobile device 120, the fob 192, and/or some other wired or wireless device.

The BANCC 187 can include an authentication manager 517, a personal profile manager 519, a command and control module 521, an authorization manager 523, an occupant manager 525, and a power manager 527, among other control components.

The authentication manager 517 may communicate biometric key information 554 to the DAT 599. The biometric key information can include biometric mode updates indicative of a particular modality with which the internal and/or external sensory systems 305 and 581 are to obtain sensory data. The biometric key information 554 may further include an acknowledgement of communication received from the biometric recognition module 597, an authentication status update including, for example, biometric indices associated with user biometric data, secured channel information, biometric location information, and/or other information. In some aspects, the authentication manager 517 may receive biometric key administration requests 556 and other responsive messages from the biometric recognition module 597, which can include, for example, biometric mode message responses and/or other acknowledgements.

The authentication manager 517 may further connect with the TCU 160 and communicate biometric status payload information 541 to the TCU 160 indicative of the biometric authentication status of the user 140, requests for key information, profile data, and other information. The TCU 160 may send and/or forward digital key payload 591 to the server(s) 170 via the network(s) 125, and receive digital key status payload 593 from the server(s) 170 and provide responsive messages and/or commands to the authentication manager 517 that can include biometric information payload 543.

Moreover, the authentication manager 517 may be disposed in communication with the BLEM 195, and/or the other vehicle controllers and systems 501 according to embodiments described in the present disclosure. For example, the BLEM 195 may send a PaaK wakeup message, or another initiating signal indicating that one or more components should transition from a low-power mode to a ready mode.

The authentication manager 517 may also connect with the personal profile manager 519, and the power manager 527. The personal profile manager 519 may perform data management associated with user profiles, which may be stored in the automotive computer 145 and/or stored on the server(s) 170. For example, the authentication manager 517 may send occupant seat position information 529 to the personal profile manager 519, which may include a seat position index indicative of preferred and/or assigned seating for passengers of the vehicle 105. The personal profile manager 519 may update seating indices, delete and create profiles, and perform other administrative duties associated with individualized user profile management.

The power manager 527 may receive power control commands 545 from the authentication manager 517, where the power control commands are associated with biometric authentication device management including, for example, device wakeup causing the biometric recognition module 597 and/or the DAT 199 to transition from a low power (standby mode) state to a higher power (e.g., active mode) state. The power manager 527 may send power control acknowledgements 551 to the authentication manager 517 responsive to the control commands 545. For example, responsive to the power and control commands 545 received from the authentication manager 517, the power manager 527 may generate a power control signal 565 and send the power control signal to the biometric recognition module. The power control signal 565 may cause the biometric recognition module to change power states (e.g., wakeup, etc.). The biometric recognition module may send a power control signal response 567 to the power manager 527 indicative of completion of the power control signal 565.

The authentication manager 517 and/or the personal profile manager 519 may further connect with the command and control module 521, which may be configured and/or programmed to manage user permission levels, and control vehicle access interface(s) for interfacing with vehicle users. The command and control module 521 may be and/or include, for example, the BCM 193 described with respect to FIG. 1. For example, the authentication manager 517 may send command and control authentication information 531 that cause the command and control module 521 to actuate one or more devices according to successful or unsuccessful authentication of a device, a signal, a user, etc. The command and control module 521 may send acknowledgements and other information including, for example, vehicle lock status 533 to the authentication manager 517.

The occupant manager 525 may connect with the authentication manager 517, and communicate occupant change information 557 indicative of occupant changes in the vehicle 105 to the authentication manager 517. For example, when occupants enter and exit the vehicle 105, the occupant manager 525 may update an occupant index, and transmit the occupant index as part of the occupant change information 557 to the authentication manager. The occupant manager 525 may also receive seat indices 559 from the authentication manager 517, which may index seating arrangements, positions, preferences, and other information.

The occupant manager 525 may also connect with the command and control module 521. The command and control module 521 may receive adaptive vehicle control information 539 from the occupant manager 525, which may communicate and/or include settings for vehicle media settings, seat control information, occupant device identifiers, and other information.

The occupant manager 525 may be disposed in communication with the DAT controller 199, and may communicate biometric mode update information 561 to the biometric recognition module 597, which may include instructions and commands for utilizing particular modalities of biometric data collection from the internal sensory system 305 and/or the external sensory system 581. The occupant manager 525 may further receive occupant status update information and/or occupant appearance update information (collectively shown as information 563 in FIG. 5) from the biometric recognition module 597.

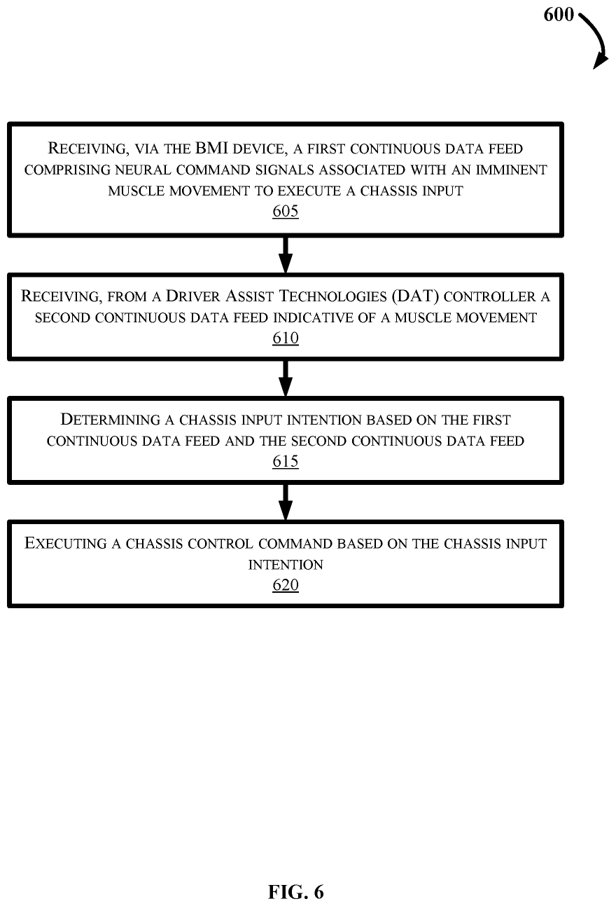

FIG. 6 is a flow diagram of an example method 600 for controlling a vehicle, using a Brain Machine Interface (BMI) device, according to the present disclosure. FIG. 6 may be described with continued reference to prior figures, including FIGS. 1-5. The following process is exemplary and not confined to the steps described hereafter. Moreover, alternative embodiments may include more or less steps than are shown or described herein, and may include these steps in a different order than the order described in the following example embodiments.

Referring to FIG. 6, at step 605, the method 600 may commence with receiving, via the BMI device, a first continuous data feed comprising neural command signals associated with an imminent muscle movement to execute a chassis input.

At step 610, the method 600 may further include receiving, from a Driver Assist Technologies (DAT) controller a second continuous data feed indicative of a muscle movement.

At step 615, the method 600 may further include determining a chassis input intention based on the first continuous data feed and the second continuous data feed. Another embodiment may further include determining the chassis input intention determining a steering ratio and gain value based on the chassis input intention score; and setting the steering ratio and gain based on the steering ratio and gain value.

At step 620, the method 600 may further include executing a chassis control command based on the chassis input intention. This step may include generating, based on the chassis input intention score, a warning notification associated with the chassis input intention. This step may further include determining a brake gain based on the chassis input intention score, and changing a brake gain value based on the brake gain setting.

This step may further include receiving a secondary input comprising one or more of a lane centering signal, a Blind Spot Information System signal, and an angular velocity signal, changing a steering ratio and gain value based on the secondary input and the chassis input intention score, and executing the chassis control command based on the steering ratio and gain value.

In one aspect, the method may further include calculating a chassis input intention score indicative of an intensity level associated with the chassis input intention; and executing the chassis control command based on the chassis input intention score.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method for controlling a vehicle using a Brain Machine Interface (BMI) device, comprising:
receiving, via the BMI device, a first continuous data feed comprising neural command signals associated with an imminent muscle movement to execute a chassis input;
receiving, from a Driver Assist Technologies (DAT) controller, a second continuous data feed indicative of a muscle movement;
determining, based on the first continuous data feed and the second continuous data feed, a chassis input intention; and
executing, based on the chassis input intention, a chassis control command.

2. The method according to claim 1, further comprising:
calculating a chassis input intention score indicative of an intensity level associated with the chassis input intention; and
executing, based on the chassis input intention score, the chassis control command.

3. The method according to claim 2, wherein executing the chassis control command comprises:
generating, based on the chassis input intention score, a warning notification associated with the chassis input intention.

4. The method according to claim 2, wherein executing the chassis control command comprises:
determining, based on the chassis input intention score, a steering ratio and gain value; and
setting, based on the steering ratio and gain value, the steering ratio and gain score.

5. The method according to claim 2, wherein executing the chassis control command comprises:
determining, based on the chassis input intention score, a brake gain; and
changing, based on a brake gain setting, a brake gain value.

6. The method according to claim 5, further comprising:
receiving a secondary input comprising one or more of a lane centering signal, a Blind Spot Information System signal, and an angular velocity signal;
changing, based on the secondary input and the chassis input intention score, a steering ratio and gain value; and
executing, based on the steering ratio and gain value, the chassis control command.

7. The method according to claim 6, wherein the steering ratio and gain value is further based on a reinforcement learning model for steering wheel position, the reinforcement learning model comprising a reward for decreased steering wheel angular velocity and a negative reward with an increased angular velocity in the steering wheel position.

8. The method according to claim 2, further comprising:
receiving a secondary input comprising one or more of a pre-collision assist signal, an anti-lock braking signal, and a brake pedal position signal;
changing, based on the secondary input and the chassis input intention score, a brake gain value; and
executing, based on the brake gain value, the chassis control command by actuating a vehicle brake.

9. The method according to claim 8, wherein the brake gain value is further based on a reinforcement learning model for brake control, the reinforcement learning model comprising a reward for decreased brake pedal velocity and a negative reward for increased brake pedal velocity.

10. The method according to claim 1, further comprising:
training the BMI device to interpret neural data generated by a motor cortex of a user and correlating the neural data to the chassis control command.

11. A system programmed to control a vehicle using a Brain Machine Interface (BMI) device, comprising:
a processor; and
a memory for storing executable instructions, the processor programmed to execute the instructions to:
receive, via the BMI device, a first continuous data feed comprising neural command signals associated with an imminent muscle movement to execute a chassis input;
receive, from a Driver Assist Controller (DAC), a second continuous data feed indicative of a muscle movement;
determine a chassis input intention based on the first continuous data feed and the second continuous data feed; and
execute a chassis control command based on the chassis input intention.

12. The system according to claim 11, wherein the processor is further programmed to:
calculate a chassis input intention score indicative of an intensity level associated with the chassis input intention; and
execute the chassis control command based on the chassis input intention score.

13. The system according to claim 12, wherein the processor is further programmed to execute the chassis control command by executing the instructions to:
generate, based on the chassis input intention score, a warning notification associated with the chassis input intention.

14. The system according to claim 12, wherein the processor is further programmed to execute the chassis control command by executing the instructions to:
determine a steering ratio and gain value based on the chassis input intention score; and
set the steering ratio and gain value based on a steering ratio and gain score.

15. The system according to claim 12, wherein the processor is further programmed to execute the chassis control command by executing the instructions to:
determine a brake gain value based on the chassis input intention score; and
change a brake gain value based on the brake gain setting.

16. The system according to claim 15, wherein the processor is further programmed to execute the instructions to:
receive a secondary input comprising one or more of a lane centering signal, a Blind Spot Information System signal, and an angular velocity signal;
change a steering ratio and gain value based on the secondary input and the chassis input intention score; and
execute the chassis control command based on the steering ratio and gain value.

17. The system according to claim 16, wherein, wherein the steering ratio and gain value is further based on a reinforcement learning model for steering wheel position, model comprising a reward for decreased steering wheel angular velocity, and a negative reward with an increase in the steering wheel angular velocity.

18. The system according to claim 12, wherein the processor is further programmed to execute the instructions to:
receive a secondary input comprising one or more of a pre-collision assist signal, an anti-lock braking signal, and a brake pedal position signal;
change a brake gain value based on the secondary input and the chassis input intention score; and
execute the chassis control command by actuating a vehicle brake based on the brake gain value.

19. The system according to claim 18, wherein the processor is further programmed to execute the instructions to:
wherein the brake gain value is further based on a reinforcement learning model for brake control, the reinforcement learning model comprising a reward for decreased brake pedal velocity, and a negative reward for increased brake pedal velocity.

20. A non-transitory computer-readable storage medium in a vehicle controller, the computer-readable storage medium having instructions stored thereupon which, when executed by a processor, cause the processor to:
receive, via a Brain Machine Interface (BMI) device, a first continuous data feed comprising neural command signals associated with an imminent muscle movement to execute a chassis input;
receive, from a Driver Assist Controller (DAC), a second continuous data feed indicative of the muscle movement;
determine a chassis input intention based on the first continuous data feed and the second continuous data feed; and
execute a chassis control command based on the chassis input intention.
